(19) United States
(12) Patent Application Publication
(10) Pub. No.: US 2025/0249777 A1
(43) Pub. Date: Aug. 7, 2025

(54) HIGH DENSITY ELECTRIC VEHICLE CHARGING SUPPLY EQUIPMENT (EVSE)

(71) Applicant: Octochi Inc., Fairfax, VA (US)

(72) Inventors: Christopher Pitman, Fairfax, VA (US); Robert Ritchie, Brookeville, MD (US)

(73) Assignee: Octochi Inc., Fairfax, VA (US)

(21) Appl. No.: 19/042,731

(22) Filed: Jan. 31, 2025

Related U.S. Application Data
(60) Provisional application No. 63/549,162, filed on Feb. 2, 2024.

(51) Int. Cl. B60L 53/65; B60L 53/16; B60L 53/63; B60L 53/66; B60L 53/67

(52) U.S. Cl. CPC B60L 53/65; B60L 53/16; B60L 53/63; B60L 53/665; B60L 53/67; B60L 2240/72

(57) ABSTRACT

Devices, methods, and systems for EV charging. Some implementations provide an EV charging subscription service to apartment residents. Infrastructure is installed in a parking facility. When residents subscribe, they are assigned a parking spot with a charging port that matches their vehicle. In some implementations, hardware and software assume that many vehicles are charged, that parking spots are assigned to a specific car, and that driving behavior averages out over many vehicles.

### TECHNICAL FIELD

This application relates to electric battery charging, and in particular, to battery charging for electric vehicles.

### BACKGROUND OF THE INVENTION

Current multi-port vehicle charging stations typically integrate 2-4 ports in a single charging station, and are positioned such that vehicles connect to the single charging station from parking spaces adjacent to the charging station. Typically, users enter into an explicit transaction each time they charge a vehicle, such as by paying at the charger via credit card.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a block diagram showing an example charging station and ports;

FIG. 2 is a block diagram showing an example port with a modular cover installed;

FIG. 3 is a block diagram showing the example port shown in FIG. 2 without the modular cover installed;

FIG. 4 is a block diagram illustrating the example charging station and ports shown and described with respect to FIGS. 1-3, positioned to serve an example configuration of parking spaces;

FIG. 5 is a block diagram illustrating the example charging station and ports shown and described with respect to FIGS. 1-3, positioned to serve another example configuration of parking spaces;

FIG. 6 is a block diagram illustrating an example facility-wide charging system;

FIG. 7 is a block diagram illustrating aspects of the example facility-wide charging system shown and described with respect to FIG. 6, in further detail;

FIG. 8 is a flow chart illustrating an example method for installing and configuring a charging station and associated ports, e.g., as shown and described with respect to FIGS. 1-5;

FIG. 9 is a flow chart illustrating an example method for configuring a port for a particular user, and for charging a vehicle;

FIG. 10 is a flow chart illustrating an example method for intelligent charge planning, e.g., implemented in a facility-wide charging system as shown and described with respect to FIG. 6;

FIG. 11 is a flow chart illustrating example charging using a distributed charging system, e.g., as shown and described with respect to FIG. 6;

FIG. 12 is a flow chart illustrating example proximity-based authentication of a user with a charging system, e.g., as shown and described with respect to FIGS. 1-5 and/or FIG. 6.

FIG. 13 is a flow chart illustrating example charging station control of charging of a vehicle based on proximity detection; and

FIG. 14 is a flow chart illustrating example load manager charge scheduling.

### DETAILED DESCRIPTION

Some implementations provide an electric vehicle (EV) charging subscription service to apartment residents. Infrastructure is installed in a parking facility. When residents subscribe, they are assigned a parking spot with a charging port that matches their vehicle. In some implementations, hardware and software assume that many vehicles are charged, that parking spots are assigned to a specific car, and that driving behavior averages out over many vehicles.

Some implementations provide a method for vehicle battery charging. A connection indication is received, which indicates that a vehicle has been connected to a charging station. A proximity indication is received, which indicates that a registered vehicle and/or registered user associated with the charging station is proximate to the charging station. Charging of a battery of the vehicle via the charging station is initiated responsive to the proximity indication indicating that the registered vehicle and/or registered user is proximate to the charging station, initiating

In some implementations, the proximity indication indicates whether the registered vehicle and/or registered user is within a threshold distance from the charging station, within a structure associated with the charging station, within a boundary associated with the charging station, within a geofence associated with the charging station, and/or connected to a wireless network associated with the charging station. In some implementations, the connection indication indicates whether the registered vehicle and/or a vehicle associated with the registered user is connected to the charging station, is within a structure associated with the charging station, and/or is connected to a wireless network associated with the charging station. In some implementations, the connection indication indicates that a vehicle has been connected to a specific port.

In some implementations, a behavioral model of the registered user and/or a behavioral model of the registered vehicle is generated or updated based on the initiation of the charging of the battery of the vehicle via the charging station. In some implementations, a charging schedule generated or updated based on the behavioral model of the registered user and/or the behavioral model of the registered vehicle. In some implementations, charging of the battery of the vehicle via the charging station is controlled based on the behavioral model of the registered user and/or the behavioral model of the registered vehicle.

Some implementations provide a device for vehicle battery charging. The device includes circuitry configured to receive a connection indication indicating that a vehicle has been connected to a charging station. The device also includes circuitry configured to receive a proximity indication indicating that a registered vehicle and/or registered user associated with the charging station is proximate to the charging station. The device also includes circuitry configured to initiate charging of a battery of the vehicle, via the charging station, responsive to the proximity indication indicating that the registered vehicle and/or registered user is proximate to the charging station.

In some implementations, the proximity indication indicates whether the registered vehicle and/or registered user is within a threshold distance from the charging station, within a structure associated with the charging station, within a boundary associated with the charging station, within a geofence associated with the charging station, and/or connected to a wireless network associated with the charging station. In some implementations, the connection indication indicates whether the registered vehicle and/or a vehicle associated with the registered user is connected to the charging station, is within a structure associated with the charging station, and/or is connected to a wireless network associated with the charging station. In some implementations, the connection indication indicates that a vehicle has been connected to a specific port.

Some implementations also include circuitry configured to generate or update a behavioral model of the registered user and/or a behavioral model of the registered vehicle based on the initiation of the charging of the battery of the vehicle via the charging station. Some implementations also include circuitry configured to generate or update a charging schedule based on the behavioral model of the registered user and/or the behavioral model of the registered vehicle. Some implementations also include circuitry configured to control the charging of the battery of the vehicle via the charging station based on the behavioral model of the registered user and/or the behavioral model of the registered vehicle.

Some implementations provide a non-transitory computer-readable medium which includes instructions for a processor to receive a connection indication indicating that a vehicle has been connected to a charging station; receive a proximity indication indicating that a registered vehicle and/or registered user associated with the charging station is proximate to the charging station; and responsive to the proximity indication indicating that the registered vehicle and/or registered user is proximate to the charging station, initiate charging of a battery of the vehicle via the charging station. In some implementations, the proximity indication indicates whether the registered vehicle and/or registered user is within a threshold distance from the charging station, within a structure associated with the charging station, within a boundary associated with the charging station, within a geofence associated with the charging station, and/or connected to a wireless network associated with the charging station. In some implementations, the connection indication indicates whether the registered vehicle and/or a vehicle associated with the registered user is connected to the charging station, is within a structure associated with the charging station, and/or is connected to a wireless network associated with the charging station.

In some implementations, the connection indication indicates that a vehicle has been connected to a specific port. In some implementations, the non-transitory computer-readable medium also includes instructions for a processor to generate or update a behavioral model of the registered user and/or a behavioral model of the registered vehicle based on the initiation of the charging of the battery of the vehicle via the charging station. In some implementations, the non-transitory computer-readable medium also includes instructions for a processor to generate or update a charging schedule based on the behavioral model of the registered user and/or the behavioral model of the registered vehicle.

The following terms are used herein:

Charging Station: An enclosure installed near multiple parking spots, with electronics supporting multiple cars charging, either simultaneously or in sequence, or a combination of both. The charging station may have no human interface. Each charging station has 1 to N wiring boxes, where conduit and wiring run from the charging station to each wiring box. Each charging station connects to a single electrical circuit, and multiple charging stations may connect to the same circuit. Charging stations may form a wireless mesh allowing communication across charging stations and with a load manager.

Wiring Box: A receptacle is installed near or adjacent to each parking spot served by the charging station, with wiring running from the charging station to the wiring box, where it terminates in a plug. In some implementations, the plug is Anderson Power Pole™-based. An electrician mounts the wiring box at the time of installation.

Cover Plate: A cover or “block-off” plate installed over the wiring box when the wiring box has no subscribed user.

Modular Connector: When a customer signs up for a parking spot, the cover plate is replaced by a Modular Connector that mates with the wiring box and the plug connecting to the charging station. Modular connectors match the customer's car. The wiring box and modular connector are configured such that a non-electrician can safely install or replace the modular connector. A wiring box connected to a charging station and mounted with a modular connector may be referred to as a charging port, or port.

Load Management System: Also referred to as a load manager. A device that manages one or more charging stations, coordinating when each vehicle is charged by planning the allocation of the limited capacity of each circuit. The load management system joins the wireless mesh and uses it for system-wide coordination of charging.

Some aspects relate to a single charging station connected to many satellite ports, each satellite port installed in an individual parking spot.

Current multi-port charging stations typically integrate 2-4 ports in a single device, and are positioned such that vehicles connect to the single charging station from parking spaces adjacent to the charging station. Such charging stations typically require dedicated electrical circuits and are limited by the number of parking spots that can be reached by charging leads connected to the single charging device (typically two parking spaces, in most garages).

Accordingly, in some implementations, several ports (e.g., 10-16 charging ports in some implementations) are connected to a single shared charging station via electrical and communications cabling such that each port is adjacent to a separate parking space (or multiple separate parking spaces), from which a charging lead is connectable between a vehicle in the parking space and the port. Additionally, any number of charging stations can be installed on a single electrical circuit. This allows further oversubscription of the shared infrastructure, potentially useful in extremely high-density deployments like airports, where it may make sense for 70-80 ports to exist on a single circuit. In this context, oversubscription indicates that the total potential charging draw of all vehicles subscribed to the infrastructure (e.g., assigned to a port of the same charging station) exceeds the amount of charge that the infrastructure is capable of supplying simultaneously.

In some implementations, this can have the advantage of serving a greater number of parking spaces by a single shared charging station, and sharing a charging station among several ports can have the advantage of reducing the cost of deployment per parking spot, both for the charging hardware and for the supporting electrical infrastructure.

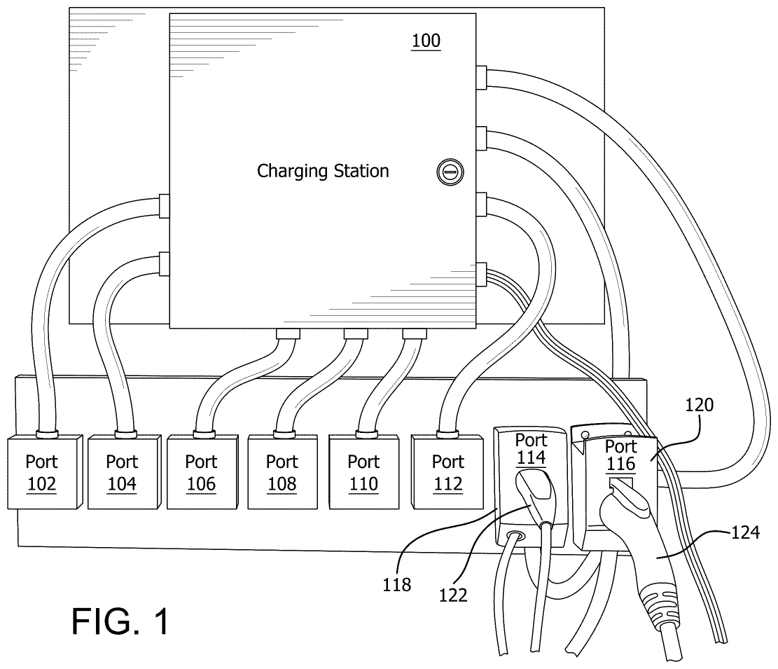

FIG. 1 is a block diagram showing an example charging station 100. Charging station 100 includes any suitable power delivery device and/or system for providing charging power to vehicles, vehicle batteries, and/or any other battery, charging system, or other device. In this example, charging station 100 is connected to eight ports 102, 104, 106, 108, 110, 112, 114, 116. Six of the eight ports (102, 104, 106, 108, 110, 112) are “blocked off” using a block-off plate or cover. The two right-most ports (114, 116) in the example of FIG. 1 are each equipped with a connector 118, 120 for a charging lead 122, 124 instead of a block-off plate or cover. Ports 114 and 116 are equipped with different charging connectors 118, 120 in this example (e.g., ports 114 and 116 are different types of charging connectors, such as connectors following different standards), and are shown connected to compatible charging leads 122, 124. For example, charging lead 122 is compatible with charging connector 114, but in some implementations is not compatible with charging connector 116. Similarly, charging lead 124 is compatible with charging connector 116, but in some implementations is not compatible with charging connector 114. In some implementations, each charging connector (e.g., charging connectors 118, 120) is implemented as or with a modular cover that mates with a port (e.g., port 114 or 116) and includes a connector that is compatible with a vehicle associated with the port and/or authorized user of the port, for charging a battery of the vehicle. For example, in some implementations the connecter includes, e.g., a Society of Automotive Engineers (SAE) J1772 connector (J-plug), International Electrotechnical Commission (IEC) 62196 (Type 1 connector), North-American Charging Standard (NACS), Tesla™ connector, or any other suitable connector.

It is noted that any suitable number of ports are connectable to charging station 100 in other implementations, and any number of the ports are blocked off or equipped with various charging connectors in other implementations. The configuration of charging station 100 and ports 102-116 shown in the figure is exemplary only, and it is noted that ports are positionable in any suitable orientation or at any suitable distance from the charging station in other implementations (e.g., as described herein). Ports are addable and removable from the charging station as desired in some implementations.

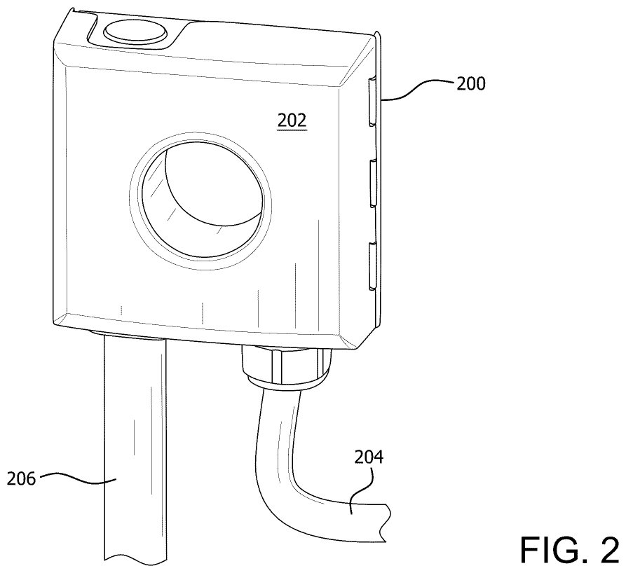

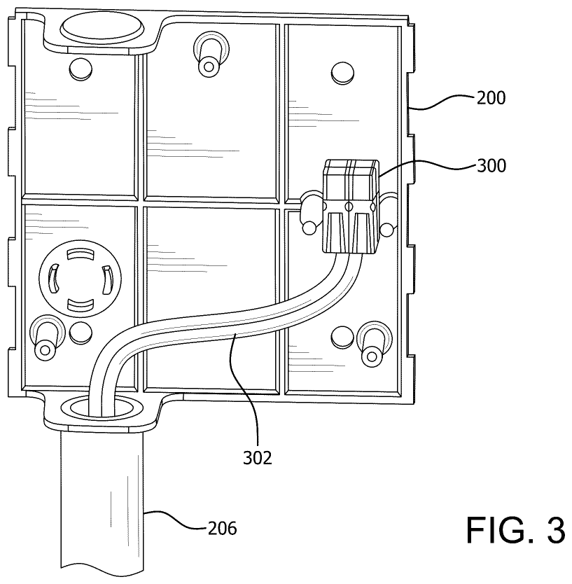

FIG. 2 is a block diagram showing an example port 200 with a modular cover 202 installed. FIG. 3 is a block diagram showing example port 200 shown in FIG. 2 without the modular cover 202 installed. FIG. 3 shows a power connector 300 within the example port 202 that is connectable to the modular cover 202 to provide power (e.g., from a power line 302 via conduit 206) to a vehicle via a charging lead 204 which is connected to or a part of the modular cover. In some implementations, the power connector 300 is connectable to modular cover 202 without tools, or is otherwise user-installable (e.g., by a non-electrician). In some implementations, the modular cover 202 is connectable to port 200 without tools, or is otherwise user-installable (e.g., by a non-electrician). In some implementations, the charging lead 204 is compatible with a vehicle associated with the port and/or authorized user of the port, for charging a battery of the vehicle. For example, in some implementations the charging leads includes, e.g., a Society of Automotive Engineers (SAE) J1772 connector (J-plug), International Electrotechnical Commission (IEC) 62196 (Type 1 connector), North-American Charging Standard (NACS), Tesla™ connector, or any other suitable connector.

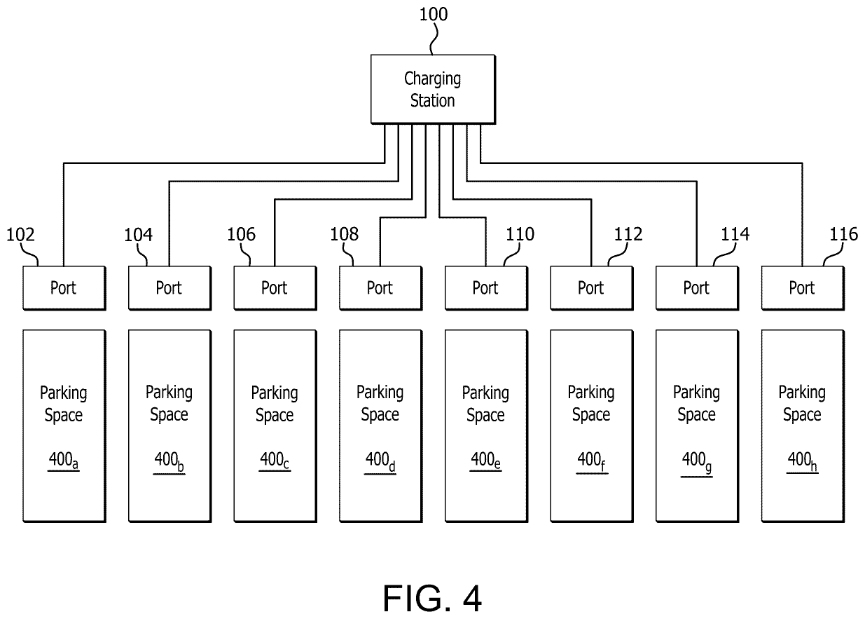

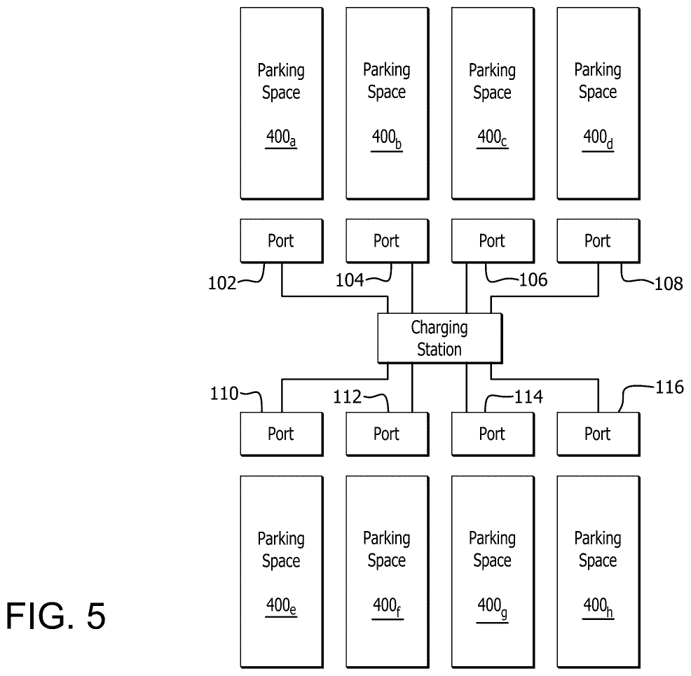

FIGS. 4 and 5 are block diagrams illustrating the example charging station and ports shown and described with respect to FIGS. 1-3, positioned to serve different configurations of parking spaces 400a, 400b, 400c, 400d, 400e, 400f, 400g, 400h (e.g., in a parking lot, garage, or other parking structure).

It is noted that in some implementations, only a subset of the ports (e.g., ports 102-116) connected to a charging station (e.g., charging station 100) are capable of providing charge to a vehicle at the same time. Thus, it may be desired to provide load management and charge planning, e.g., to facilitate charging of all vehicles connected to the charging station via the ports in a suitable fashion.

Accordingly, some aspects relate to a distributed (e.g., parking lot- or garage-wide) charging system. In some implementations, the charging system (e.g., charging station 100 or a device connected to or in communication with charging station 100, e.g., wirelessly) includes load management hardware that controls and monitors charging via the charging stations. For example, in some implementations, the load management hardware schedules charging of vehicles connected to a charging station, e.g. as discussed herein.

Some existing charging solutions include load management systems; however, such chargers are typically self-contained units which seek permission to operate from a load management system. For example, some existing charging stations determine an amount of current to offer to a vehicle and then request permission to provide this amount of current to the vehicle from a local load manager. The local load manager detects whether the circuit and/or electrical panel supplying power to the charging station has enough capacity to provide the requested amount of current. If there is not enough capacity, the local load manager may send a request to another charging station on the circuit and/or electrical panel to reduce its current consumption to allow for the original charging station to supply the requested current, and may notify the original charging station that it may use the requested amount of current.

Such existing charging solutions are reactive, basing load management decisions on present current demand from presently connected vehicle batteries and their present current draw. Such reactive systems may not be able to base load management decisions on predicted future current demand.

Accordingly, in some implementations, charging stations (e.g., charging station 100) are implemented as “thin clients”, where some or all charging decisions (e.g., whether to begin or end charging (e.g., via a particular port and/or to a particular vehicle), the amount of current to offer a charging vehicle and/or via a particular port, and/or whether an authorized user and/or vehicle is in proximity of the corresponding port) are made by a separate load manager device and/or load management system. In other words, in some implementations, charging stations include no control functionality (e.g., other than on-off switch (e.g., relay), control pilot generation and reading hardware, and one or more safety sensors (e.g., ground fault, ground presence, control pilot out-of-range, etc. that is controlled by a separate load manager device and/or load management system), or limited control functionality, and separate load management hardware (e.g., a server running load management software and in communication with the charging station) provides control of the charging stations.

Unlike existing installations that include several independently-operating integrated charging systems, some implementations provide a virtual facility-wide charging system. In some implementations, this has the advantage of simplifying management of the overall charging infrastructure and facilitates intelligent charging strategies (e.g., as described herein). Current charging systems are based fundamentally on low-density charging, and are not designed for high-density charging from the start.

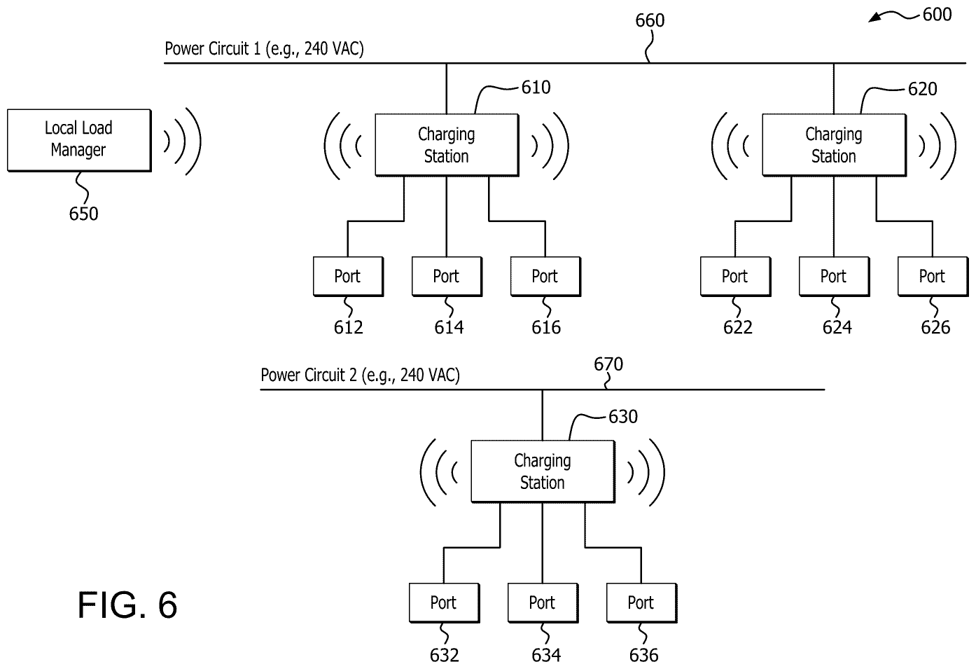

FIG. 6 is a block diagram illustrating an example facility-wide charging system 600. Example system 600 includes three charging stations 610, 620, 630 and their connected ports 612, 614, 616, 622, 624, 626, 632, 634, 636 and a load manager 650. In some implementations, charging stations 610, 620, and/or 630 are substantially similar to charging station 100 as shown and described with respect to FIGS. 1-5. In some implementations, ports 612, 614, 616, 622, 624, 626, 632, 634, 636 are substantially similar to port 200 as shown and described with respect to FIGS. 2-5. In example system 600, charging stations 610 and 620 are connected to a first power circuit 660, and a charging station 630 is connected to a second power circuit 670. Power circuits 660, 670 provide electrical power (e.g., mains voltage) which charging stations 610, 620, 630 are configured to distribute to vehicles (or other batteries in some implementations) via their connected ports 612, 614, 616, 622, 624, 626, 632, 634, 636. It is noted that the architecture and topology shown in FIG. 6 is exemplary, and any suitable number, combination and/or configuration of charging stations, power circuits, and ports is possible in other implementations.

In example system 600, load manager 650 includes control hardware suitable for communicating with and commanding the charging stations 610, 620, 630. In some implementations, load manager 650 is, is implemented by, includes, and/or is included in a computer server or other computing device configured to communicate with and control charging stations 610, 620, 630. In example system 600, load manager 650 communicates wirelessly with charging stations 610, 620, 630 as shown. In some implementations, the wireless communication functionality is implemented using any suitable wireless communications technology, such as WiFi™ (i.e., Institute of Electrical and Electronics (IEEE) standard) and/or cellular (e.g., Third Generation Partnership Project (3GPP) LTE or 5G standards). It is noted that the load manager 650 communicates with the charging stations 610, 620, 630 in any suitable manner in other implementations (e.g., via wired connections).

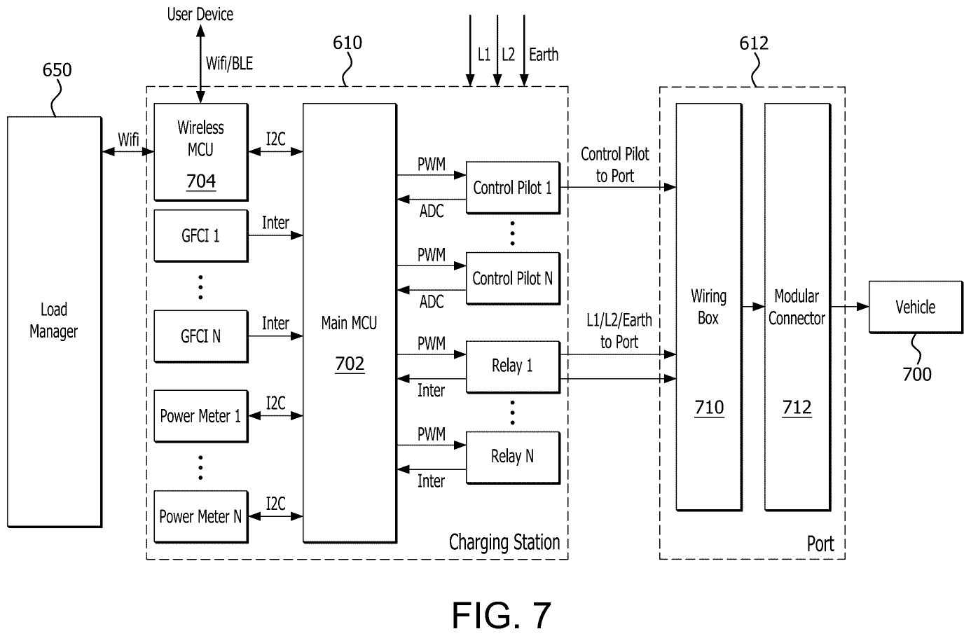

FIG. 7 is a block diagram illustrating aspects of the example facility-wide charging system shown and described with respect to FIG. 6, in further detail. FIG. 7 shows load manager 650, one of the charging stations (charging station 610 in this example), one of the ports attached to charging station 610 (port 612 in this example), and a vehicle 700 connected to port 612. Port 612 is in communication with charging station 610 via wiring box 710 (which may be arranged and/or implemented according to aspects of port 200 shown and described with respect to FIG. 3), and is in communication with vehicle 700 via modular connector 712 (which may be arranged and/or implemented according to aspects of port 200 shown and described with respect to FIGS. 2-3). This arrangement is exemplary. In some implementations, the system includes fewer components, additional components, different components, and/or a combination of some or all of these components and additional components.

In this example, charging station 610 includes a main control unit (main MCU) 702, circuitry for controlling power to ports, including port 612 (Relay 1 . . . Relay N and Control Pilot 1 . . . Control Pilot N), ground fault circuitry (GFCI 1 . . . GFCI N) associated with each of the ports, power meters associated with each of the ports (Power Meter 1 . . . Power Meter N), and a wireless communications controller and transceiver (Wireless Controller) 704. In some implementations, main MCU 702 is, is implemented by, includes, and/or is included in a control device which provides control of the other components in charging station 610. In some implementations, main MCU 702 is implemented in any suitable way using any suitable hardware and/or software. For example, in some implementations, main MCU 702 is, is implemented by, includes, and/or is included in a microcontroller, application-specific integrated circuit (ASIC), field-programmable gate array (FPGA), processor, or any other suitable embedded-control or other control device. In some implementations, Control Pilot 1 . . . Control Pilot N provide a control pilot from charging station 610 to vehicle 700 via port 612. In some implementations, the control pilot is or includes a PWM voltage provided to vehicle 700 from charging station 600 via port 612, e.g., in a manner as set forth in the SAE J1772 standard, or any other suitable automotive charging standard, other charging standard, or other standard. In some implementations, when a vehicle is connected, charging station 610 detects vehicle 700, e.g., based on a resistance which lowers the voltage observed by charging station 610 via port 612 (e.g., state B1 in SAE J1772). In some implementations, when charging station 610 is ready to charge vehicle 700, it changes the duty cycle of the control pilot (e.g., via Control Pilot 1 hardware in this example) to communicate the maximum current that vehicle 700 is allowed to draw (e.g., as defined in SAE J1772 as a piecewise linear equation; e.g., where a 10% duty cycle indicates that the vehicle should draw up to 6 Amps. e.g., state B2 in SAE J1772). In some implementations, when vehicle 700 is ready to charge, it adds an additional parallel resistance, lowering the voltage observed by charging station 610, triggering the charging station 610 to energize the corresponding port relay (e.g., state C in SAE J1772) which is Relay 1 in this example. In some implementations, two port relays are energized, closing both energized lines of a split-phase 240V circuit. In some implementations, a single relay (e.g., a double-pole, double-throw (DPDT) relay) integrates the closing of both energized lines of a split-phase 240V circuit in a single relay. This arrangement is exemplary. In some implementations, the charging station includes fewer components, additional components, different components, and/or a combination of some or all of these components and additional components. In some implementations, some or all of these components are implemented externally to the charging station and/or are otherwise not integral to the structure of the charging station. For example, the implementation of a control pilot in the charging station is exemplary only, and it is understood that in some implementations the charging station implements any suitable communication standard other than, or in addition to, a control pilot and/or the SAE J1772 charging standard. In some implementations, the charging station implements a proximity pilot or “plug present” signal.

The load manager communicates with the charging station over a wireless connection via the wireless MCU. In this example, these wireless communications follow the WiFi™ standard, however it is noted that any suitable wireless or other communications are usable in other implementations. The charging station is also configured to communicate with a user device (e.g., smartphone or vehicle transceiver) via the wireless MCU. In this example, these wireless communications follow the WiFi™ or BLE standards, however it is noted that any suitable wireless or other communications are usable in other implementations. In some implementations, the load manager communicates an indication of a current allocation (e.g., how much current should be allocated and/or supplied to each port of the charging station), a reset indication (e.g., to set or reset the charging station to a particular state), a firmware, software, and/or configuration update (e.g., to set, change, select, or update firmware or software on the charging station, and/or to set, change, select, or update a configuration of the charging station).

In this example, the wireless MCU is in communication with the main MCU via an Inter-Integrated Circuit (I2C) connection, however it is noted that any suitable other communications are usable in other implementations.

The ground fault circuitry (GFCI 1 . . . GFCI N) are in communication with the main MCU via an interface. In some implementations, the interface provides an interrupt signal to the MCU for ground fault interruption, or an analog signal proportional to ground fault current leakage that is monitored by the MCU. Other implementations use any suitable interface or signaling to communicate ground fault information to the MCU. The ground fault circuitry provides ground fault protection for each port.

The power meters (Power Meter 1 . . . Power Meter N) are in communication with the main MCU via I2C connections, however it is noted that any suitable other communications are usable in other implementations. The power meters record power consumed by each port. In some implementations, power consumption information is relayed to the load manager, e.g., via the wireless connection.

The control pilots (Control Pilot 1 . . . Control Pilot N) are in communication with the main MCU via Pulse Width Modulation (PWM) and/or Analog connections (e.g., analog-digital converters ADC), and with the port, however it is noted that any suitable other connections and/or communications protocols are usable in other implementations. In some implementations, main MCU 702 communicates with port 612 and connected vehicle 700 by sending a PWM signal that conveys information indicating allowed current draw and/or a state of the charging session. In some implementations, the control pilot state includes any one or more of Disconnected, Connected/No Charge Offered, Connect/Charge Offered, Charging, Ventilation Required, and/or Error states. In some implementations, the control pilot state includes fewer states, additional states, different states, and/or a combination of some or all of these states and additional states.

In some implementations, Main MCU 702 reads the control pilot (via Control Pilot 1 hardware in this example) via an analog input (ADC in FIG. 7) to determine voltage level and the state of port 612 and vehicle 700. In some implementations, changes to the control pilot in charging station 610 are triggered by load manager 650, e.g., via a wireless connection (e.g., Wifi in FIG. 7).

In some implementations relays Relay 1 . . . Relay N are controlled by main MCU 702 via a Pulse Width Modulated signal (PWM) to open and close the relay. In some implementations, the relays communicate open and closed states to main MCU 702 via an interrupt (Inter in FIG. 7), e.g., held high when the relay is successfully closed. However, it is noted that any suitable other connections are usable in other implementations. Relays Relay 1 . . . Relay N, when closed, energize the circuit to port 612 and vehicle 700. Main MCU 702 monitors the state of the relays Relay 1 . . . Relay N based on the interrupts from each relay, and in some implementations, controls Relay 1 . . . Relay N to only be closed during a charging session associated with that relay. In some implementations, if remain closed outside of a charging session, e.g., as communicated by the interrupts, charging station 610 notifies load manager 650, e.g., via a wireless connection (e.g., Wifi in FIG. 7).

It is noted that in some implementations, implementation of a facility-wide charging system (e.g., control of several charging stations and/or ports via a load manager) in this way can provide historical information to facilitate charge planning based on intelligent heuristics, such as user and/or vehicle scheduling and/or behavior, fee structures, power costs, etc.

Accordingly, some aspects relate to intelligent charge planning based on individual user and/or vehicle scheduling and/or behaviors, fee structures, power costs, etc.

Some existing load management systems apply relatively simple approaches to charge management. For example, existing load management systems simply charge cars in the order they arrive, or charge all cars equally, etc.

Accordingly, some implementations subscribe and/or assign a specific car to charge in an assigned parking spot and/or port, and predict in advance when vehicles will need charging, how much they will need, and an optimized plan for meeting those needs. Some implementations also use user behavior patterns to assign vehicles to parking spots in order to provide a mix of driving behaviors on a single charging station, allowing for more efficient utilization. In some implementations, in addition to user data, the scheduler also uses the fee structure provided by the power company supplying power to the charging station to further optimize when and how to charge vehicles.

For example, some implementations predict how much power a vehicle will need in the next charging session based on the time the vehicle was away from the garage. Some implementations also predict when the vehicle will most likely return (e.g., based on the user and/or vehicle's past behavior). Applying such techniques for all vehicles associated with the charging system facilitates development of a schedule and/or plan for supplying power from the charging station to vehicles connected to its ports. Schedules and/or plans are updated as new information arrives (e.g., as cars leave or return to their ports or to the garage). New details regarding a user and/or vehicle's behavior patterns feeds back into the model for future predictions.

In some implementations, the charging system includes load management hardware that controls and monitors charging via the charging stations. For example, in some implementations, the load management hardware schedules charging of vehicles connected to a charging station based on a schedule, which in some implementations is derived based on historical information regarding connection times, charge state, or any other suitable information. In some implementations, such scheduling or other charge control is generated and/or inferred by an artificial neural network or other machine learning structure based on the historical information (e.g., trained based on historical information).

Current solutions provide no clear relationship between a user and the charger they use, making predictive scheduling difficult or impossible. Since shared chargers incentivize users to charge occasionally (instead of always), there is a greater variability in use, and it is difficult or impossible to know whether a user will use a provider's charger or another provider's charger the next time the vehicle is charged. Accordingly, some implementations facilitate an assigned-parking space and/or assigned-port model, facilitating predictable use patterns for predictive scheduling.

Some implementations provide increased efficiency and/or utilization of the charging infrastructure by scheduling and/or planning when multiple vehicles charge. Compared to the simplistic scheduling used in the current state-of-the-art, data-based scheduling as described herein can have the advantage of allowing for more vehicles to share the same circuit while providing for charging of all of the vehicles. Some implementations may have the advantage of providing 60+% utilization of a shared circuit.

The user experience of current car chargers typically includes the user explicitly starting a transaction using a credit card, radio-frequency identification (RFID), near-field communication (NFC), or app. This is a high friction model compared to single-family home charging, where the user plugs in their car when they get home and requires no further interactions.

Accordingly, some aspects relate to automatically determining whether users are authorized to use a charging station, based on proximity.

Charging of vehicle batteries (and other batteries) involves supplying electrical power to provide the charge, and payment for the electrical power is typically a basic aspect of charging. Since payment is usually required (e.g., to the power company or a service provider), it may be desirable to ensure that the user or vehicle receiving the charge in fact pays for the electrical power.

To this end, some approaches to vehicle charging involve the user entering into an explicit transaction each time they charge a vehicle. For example, in some cases the user will pay at the charger via using a credit card and/or via a smartphone or mobile app, NFC/RFID tags, QR code, or the like, each time they charge. This is typically necessary because many different users use the charging station.

The process can be cumbersome and typically must be repeated each time the user starts a new charging session. Thus, it may be desired to provide a mechanism for payment that overcomes these inconveniences.

Accordingly, in some implementations, a specific vehicle (and/or specific drivers of the vehicle) are assigned to a parking spot and/or charging point, and use a mobile app to detect when the driver and/or vehicle is near their parking spot and/or charging station. When the user connects the vehicle to the charging station, the system (e.g., an authentication management device, such as an internet connection server, cloud hosted server, the charging station, a load manager, etc.) verifies that a registered user is near the vehicle. In some implementations, a combination of the registered user and/or registered vehicle being connected to a charging station assigned to that user and/or vehicle, and the registered user and/or registered vehicle being detected as proximate to the charging station, that facilitates verification. In some implementations, proximity detection of the registered user facilitates low friction transactions, e.g., for vehicles that do not support a standard protocol for vehicle authentication, such as Plug & Charge (ISO 15118), which are not currently commonly implemented. If the user and/or vehicle are detected as proximate to the charging station, in some implementations, charging starts automatically; (i.e., with no further, direct user intervention).

Because existing designs do not provide a clear assignment of driver and/or vehicle to the charging station, it is contrary to such existing designs to have a frictionless authentication scheme based on the user's presence. For example, if a registered user were to plug into a typical current charger at a shopping center, the user could be one of thousands of users, and so it is unclear which user to authenticate. There may also be multiple users in physical proximity to the shared station; thus, even if they are nearby, it is unclear whether a particular user is charging. Accordingly, some implementations provide for assigned parking/charging spots. If the user and/or vehicle's presence cannot be verified, a notification is sent to the user asking them to confirm that they have plugged in a vehicle.

In some implementations, a specific vehicle and/or user is assigned to a parking spot and/or charging station (e.g., wiring box powered by a charging station). In some implementations, the user and/or vehicle is registered with the system and/or otherwise associated with the charging station. An application (e.g., mobile app) associated with the specific vehicle and/or user detects or otherwise determines when the specific vehicle and/or user is near their parking spot and/or charging station (e.g., within a threshold distance, or within a boundary or structure such as a parking garage, etc.) In some implementations, the application runs on a vehicle computer, smartphone, other mobile communications and/or other computing device, and determines that the resident is near their parking spot and/or charging station when the vehicle computer, smartphone, other mobile communications and/or other computing device is within a threshold distance of the charging station, or within a boundary or structure such as a parking space, parking level, parking garage, etc.)

When the user initiates charging (e.g., plugs the vehicle into the charging station, or otherwise activates charging via a control on the charging station, vehicle, mobile app, or otherwise), the system verifies that the connected vehicle and/or the user who connected the vehicle is authorized for charging.

For example, in some implementations, the system verifies that the connected vehicle and/or the user who connected the vehicle is authorized for charging based on proximity. For example, in some implementations, the system verifies that the connected vehicle and/or the user who connected the vehicle is authorized for charging if an authorized user is near an authorized vehicle, that the authorized user is near the charging station, and/or that the authorized vehicle is near the charging station. In some implementations, an authorized user is a user who is registered with the system and/or associated with the charging station and/or parking space. In some implementations, an authorized vehicle is a vehicle that is registered with the system and/or associated with the charging station and/or parking space.

In some implementations, charging may commence after it is verified, based on proximity, that the connected vehicle and/or the user who connected the vehicle is authorized for charging. In some implementations, charging starts automatically (e.g., with no direct and/or further user intervention).

In some implementations, if it is not verified based on proximity that the connected vehicle and/or the user who connected the vehicle is authorized for charging (e.g., after a threshold time has elapsed since the vehicle was connected to the charging station), a notification is sent to the user (e.g., via smartphone app or vehicle app) requesting confirmation of whether they connected a vehicle. In some implementations, charging can commence after the user confirms that they connected the vehicle even if it is not verified based on proximity that the connected vehicle and/or the user who connected the vehicle is authorized for charging.

In some implementations, user and/or vehicle proximity to the charging station is detected in one or more ways, e.g., to provide robust proximity detection. For example, in some implementations, a mobile app (e.g., smartphone or vehicle) detects proximity to the charging station based on connectivity to a wireless network (e.g., a BlueTooth™ low-energy (BLE) network and/or WiFi™ network associated with the charging station). In some implementations the mobile app detects a wireless network associated with the charging station and, in response, connects to the network and/or notifies the charging system of the proximity of the authorized user and/or authorized vehicle to the charging station.

In some implementations, user and/or vehicle proximity to the charging station is detected based on geofencing. For example, in some implementations, the mobile app detects that it is within a geofence associated with the charging station, or a parking structure such as a parking space, parking level, parking garage, etc. associated with the charging station. In some implementations, the mobile app receives a notification if the smartphone and/or vehicle enters the geofenced region. In some implementations, in response, the mobile app notifies the charging system that the user is in proximity of the charging station.

In some implementations, the mobile app records (e.g., locally on the mobile device) the time when the user was in proximity of the charging station (e.g., within the parking facility). In some implementations, if a notification is sent to the mobile app inquiring whether the authorized user and/or authorized vehicle was present when a vehicle was plugged into the port, the app responds (e.g., automatically) in the affirmative if it has recorded the authorized user and/or authorized vehicle's presence at that time.

The proximity-based authentication scheme can have the advantage of allowing users to charge their vehicle without interaction, making this everyday activity frictionless.

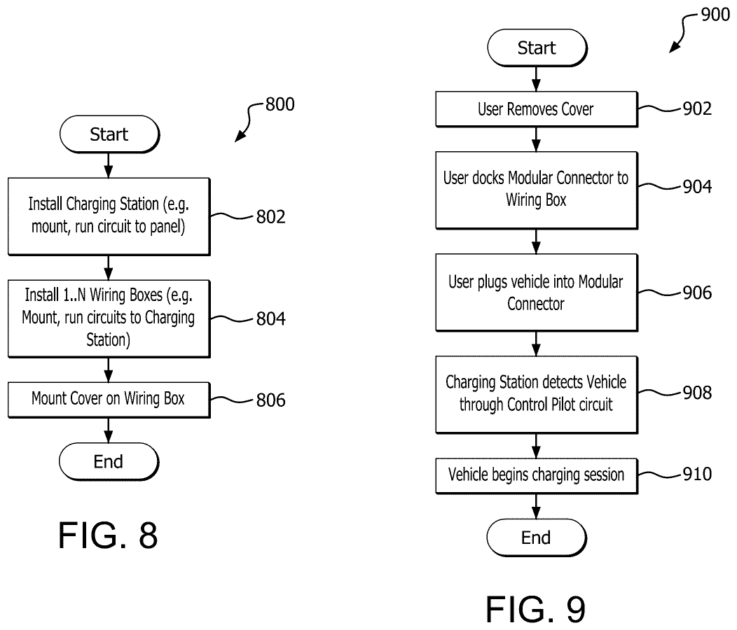

FIG. 8 is a flow chart illustrating an example method 800 for installing and configuring a charging station and associated ports, e.g., as shown and described with respect to FIGS. 1-5.

At 802, charging station is installed in a parking facility. In some implementations, the charging station is mounted and connected to a power distribution circuit (e.g., by running a power line to an electrical panel). At 804, a desired number of wiring boxes are mounted at parking locations (e.g., one for each of several parking spaces) and electrical and communications cabling is run from each wiring box to the charging station. At 806, a modular cover is mounted to each wiring box to create a port to be assigned to an assigned user or vehicle. The modular cover includes a charging connection that is compatible with the assigned vehicle (or vehicle of the assigned user). A block-off or cover plate is mounted to each wiring box not assigned to a user and/or vehicle. In some implementations, the charging station, wiring boxes, mounting cover, and/or other aspects are implemented as shown and described herein (e.g., in a manner substantially similar to charging station 100, ports 102-116, 200, and/or modular cover 202). It is noted that in some implementations, any, some, or all of these actions, including, 802, 804, and/or 806 may be combined, separated, omitted, or rearranged in any possible permutation, and further actions may be added.

FIG. 9 is a flow chart illustrating an example method 900 for configuring a port for a particular user, and for charging a vehicle.

Sometime after the installation shown and described with respect to FIG. 8, a user and/or vehicle is assigned to a port of the charging station that is not currently assigned and whose corresponding wiring box is covered with a block-off or cover plate. At 902, the user removes the cover plate and at 904 docks a modular cover to the wiring box. The modular cover includes a charging connection that is compatible with the assigned vehicle (or vehicle of the assigned user). At 906, the user connects a charging lead between the installed modular cover and the vehicle. At 908, the charging station detects the vehicle through a control pilot circuit (e.g., as discussed herein). In some implementations, the charging station confirms that the user and/or vehicle assigned to the port is proximate to the port (e.g., as discussed herein). After the detection and confirmation, at 910, charging of the vehicle commences. In some implementations, the charging commences automatically, without any further intervention from the user (e.g., beyond plugging the charging lead into the modular cover.) In some implementations, the charging station, wiring boxes, mounting cover, and/or other aspects are implemented as shown and described herein (e.g., in a manner substantially similar to charging station 100, ports 102-116, 200, and/or modular cover 202). It is noted that in some implementations, any, some, or all of these actions, including, 902, 904, 906, 908, and/or 910 may be combined, separated, omitted, or rearranged in any possible permutation, and further actions may be added.

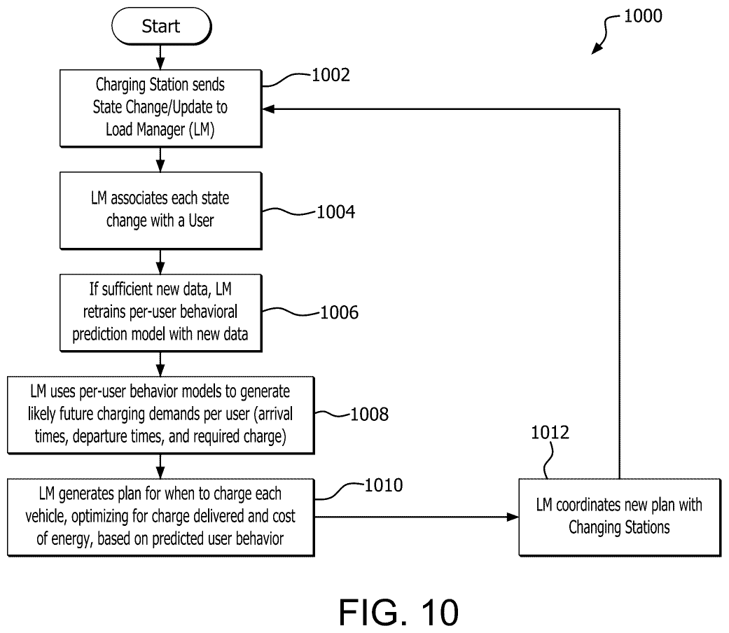

FIG. 10 is a flow chart illustrating an example method 1000 for intelligent charge planning, e.g., implemented in a facility-wide charging system as shown and described with respect to FIG. 6.

At 1002, a charging station sends information indicating a state change and/or update to a load manager. In some implementations, the information indicates a change in control pilot state (e.g., A: Disconnected, B1: Connected/No Charge Offered, B2: Connect/Charge Offered, C: Charging, D: Ventilation Required, E: Error), a change in current and/or power consumption by a charging vehicle, an amount (e.g., aggregate) of power consumption, an error state (e.g. ground fault, overcurrent, etc.) and/or charging station temperature. In some implementations, the information indicates less information, additional information, different information, and/or a combination of some or all of this information and additional information. At 1004, the load manager associates the state change with a user and/or vehicle associated with a port of the charging station. At 1006, if the information includes a sufficient change (e.g., changes state beyond a threshold), the load manager trains or re-trains a per-user behavioral prediction model based on the information. In some implementations, the per-user behavioral prediction model models charging demand for a particular port, a particular charging station, for a subset of ports and/or charging stations, and/or for all charging stations and/or ports managed by the load manager (e.g., within a parking facility). At 1008, the load manager applies the per-user behavior model or models to estimate or predict likely future charging demands, e.g., per-user (e.g., arrival times, departure times, and/or required amount of charge, etc.). At 1010, the load manager generates a schedule or plan, based on the estimate or prediction, for when to charge each vehicle. In some implementations, the schedule or plan optimizes for amount of charge delivered and/or cost of energy, e.g., based on user behavior and/or vehicle metrics, etc. At 1012, the load manager communicates and coordinates the new charging schedule or plan with the charging stations, and the flow returns to 1002. In some implementations, the charging station, wiring boxes, mounting cover, load manager, and/or other aspects are implemented as shown and described herein (e.g., in a manner substantially similar to charging station 100, ports 102-116, 200, modular cover 202, and/or load manager 650). It is noted that in some implementations, any, some, or all of these actions, including, 1002, 1004, 1006, 1008, 1010 and/or 1012 may be combined, separated, omitted, or rearranged in any possible permutation, and further actions may be added.

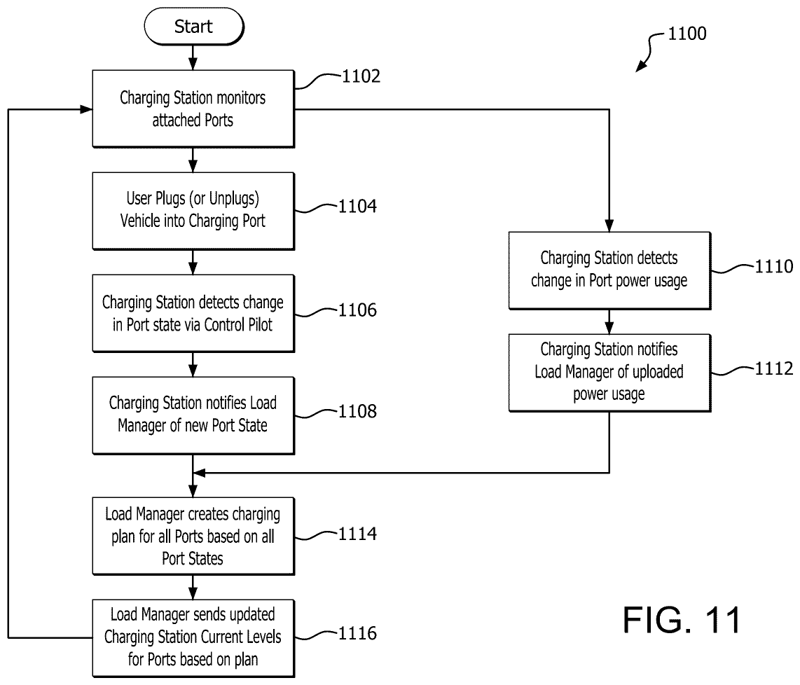

FIG. 11 is a flow chart illustrating an example method 1100 for charging using a distributed charging system, e.g., as shown and described with respect to FIG. 6.

At 1102, a charging station monitors its attached ports for connections or disconnections, or changes in power usage.

At 1104, if the charging station detects a change in connection state of a port (e.g., user plugs or unplugs vehicle), e.g., via control pilot circuitry at 1106, the charging station notifies the load manager of the change in the port connection state at 1108. At 1114, the load manager creates a charging schedule or plan for all ports in the distributed charging system based on the state of all of the ports (e.g., as shown and described with respect to FIG. 10). At 1116, the load manager sends updated control information to a subset of charging stations based on the charging schedule or plan (e.g., sends updated current levels for each port based on the charging schedule or plan), and the flow returns to 1102.

At 1110, if the charging station detects a change in power usage of a port that is connected to a vehicle, the charging station notifies the load manager of the change in power usage at 1112. At 1114, the load manager creates a charging schedule or plan for all ports in the distributed charging system based on the state of all of the ports (e.g., as shown and described with respect to FIG. 10). At 1112, the load manager sends updated control information to a subset of charging stations based on the charging schedule or plan (e.g., sends updated current levels for each port based on the charging schedule or plan), and the flow returns to 1102. In some implementations, the charging station, wiring boxes, mounting cover, load manager, and/or other aspects are implemented as shown and described herein (e.g., in a manner substantially similar to charging station 100, ports 102-116, 200, modular cover 202, and/or load manager 650). It is noted that in some implementations, any, some, or all of these actions, including 1102, 1104, 1106, 1108, 1110, 1112, 1114, and/or 1116 may be combined, separated, omitted, or rearranged in any possible permutation, and further actions may be added.

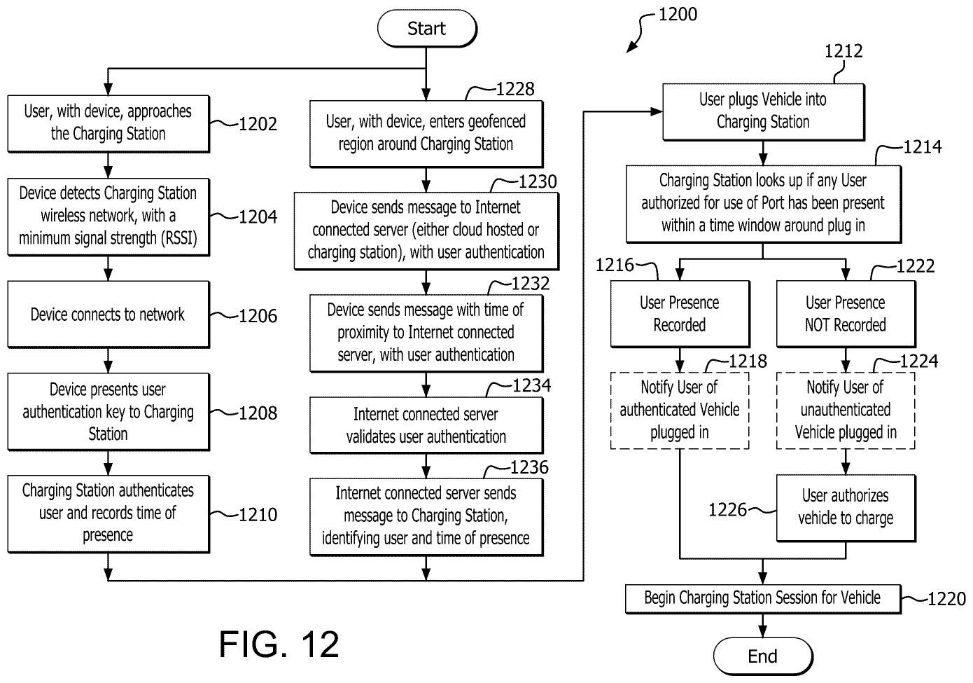

FIG. 12 is a flow chart illustrating an example method 1200 for proximity-based authentication of a user with a charging system, e.g., as shown and described with respect to FIGS. 1-5 and/or FIG. 6.

At 1202, if an authorized user of a port approaches the port and/or associated charging station with a wireless device (e.g., smartphone or vehicle communications device) running an authentication app, the device (e.g., via the app) detects a wireless network of the charging station (e.g., with a minimum signal strength, e.g., based on a minimum received signal strength indicator (RSSI) level) at 1204, the device connects to the network at 1206 and presents user authentication credentials (e.g., a user authentication key or other suitable indication) to the charging station via the network at 1208. The charging station authenticates the user based on the key or indication and records the time that the user presence began (e.g., based on the authentication time or otherwise) at 1210. The user connects the vehicle to the assigned port at 1212. Responsive to the user connecting the vehicle, the charging station determines whether a user authorized to use the port is present (or has been present during a suitable window of time including the time that the user connected the vehicle to the port) at 1214. If the charging station determines that the authorized user is present at 1216, the charging station may notify the user that an authenticated vehicle has been plugged into their assigned port at 1218, and begins charging the vehicle at 1220. If the charging station determines that the authorized user is not present at 1222, the charging station may notify the user that an unauthenticated vehicle has been plugged into their assigned port at 1224, and requests authorization from the user via the app. If the user authorizes the vehicle to charge (e.g., via the app) at 1226, the charging station begins charging the vehicle at 1220.

If an authorized user of a port enters a geofenced region around (or otherwise associated with) the port and/or associated charging station with a wireless device (e.g., smartphone or vehicle communications device) running an authentication app at 1228, the device (e.g., via the app) sends a message to an authentication management device (e.g., an internet connection server, cloud hosted server, the charging station, a load manager, etc.) with user authentication credentials (e.g., a user authentication key or other suitable indication) at 1230. The device (e.g., via the app) sends a message indicating time of proximity (e.g., time arriving or within the geofence) to the authentication management device at 1232, (e.g., along with the user authentication at 1230). The authentication management device authenticates the user at 1234 (e.g., based on the information in the received messages), and sends an indication identifying the user and time of presence to the charging station at 1236. The user connects the vehicle to the assigned port at 1212. Responsive to the user connecting the vehicle, the charging station determines whether a user authorized to use the port is present (or has been present during a suitable window of time including the time that the user connected the vehicle to the port) at 1214. If the charging station determines that the authorized user is present at 1216, the charging station may notify the user that an authenticated vehicle has been plugged into their assigned port at 1218, and begins charging the vehicle at 1220. If the charging station determines that the authorized user is not present at 1222, the charging station may notify the user that an unauthenticated vehicle has been plugged into their assigned port at 1224, and requests authorization from the user via the app. If the user authorizes the vehicle to charge (e.g., via the app) at 1226, the charging station begins charging the vehicle at 1220. It is noted that in some implementations, any, some, or all of these actions, including 1202, 1204, 1206, 1208, 1210, 1212, 1214, 1216, 1218, 1220, 1222, 1224, 1226, 1228, 1230, 1232, 1234, and/or 1236 may be combined, separated, omitted, or rearranged in any possible permutation, and further actions may be added.

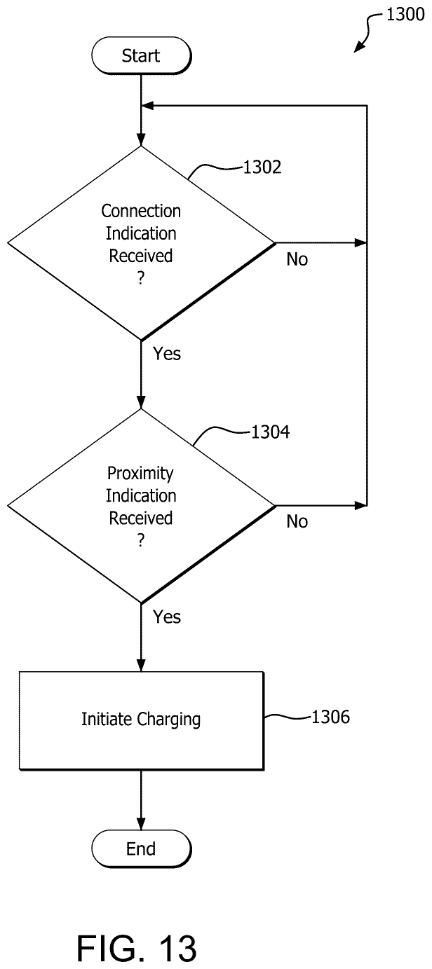

FIG. 13 is a flow chart illustrating example method 1300 for charging station control of charging of a vehicle based on proximity detection, e.g., as described herein. After a vehicle connects to its assigned port, if a connection indication is received at 1302, and a proximity indication is received at 1304, the charging station initiates charging of the vehicle connected to the port at 1306. It is noted that in some implementations, any, some, or all of these actions, including 1302, 1304, and/or 1306, may be combined, separated, omitted, or rearranged in any possible permutation, and further actions may be added.

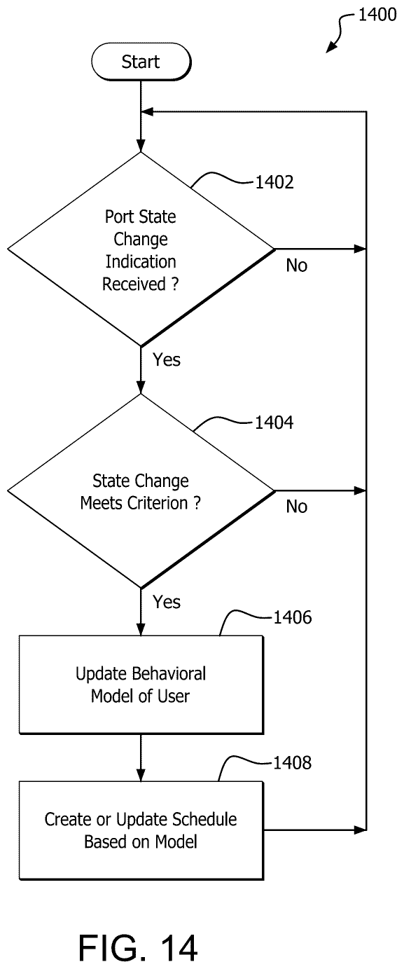

FIG. 14 is a flow chart illustrating example method 1400 for load manager charge scheduling, e.g., as described herein. If the load manager receives an indication of a port state change at 1402, and if the state change meets a criterion for model updating at 1404, the load manager creates or updates a behavioral model of the user associated with the port state change at 1406, and creates or updates a charging plan or schedule of the charging station based on the behavioral model at 1408. In some implementations, the behavioral model is based on more than one user. In some implementations, the charging plan or schedule is based on more than one behavioral model. It is noted that in some implementations, any, some, or all of these actions, including 1402, 1404, 1406, and/or 1408 may be combined, separated, omitted, or rearranged in any possible permutation, and further actions may be added.

It should be understood that many variations are possible based on the disclosure herein. Although features and elements are described above in particular combinations, each feature or element can be used alone without the other features and elements or in various combinations with or without other features and elements. For example, actions within flow charts may be omitted, or rearranged in any possible permutation, and further actions may be added.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for vehicle battery charging, the method comprising:
receiving a connection indication indicating that a vehicle has been connected to a charging station;
receiving a proximity indication indicating that a registered vehicle and/or registered user associated with the charging station is proximate to the charging station; and
responsive to the proximity indication indicating that the registered vehicle and/or registered user is proximate to the charging station, initiating charging of a battery of the vehicle via the charging station.

2. The method of claim 1, wherein the proximity indication indicates whether the registered vehicle and/or registered user is within a threshold distance from the charging station, within a structure associated with the charging station, within a boundary associated with the charging station, within a geofence associated with the charging station, and/or connected to a wireless network associated with the charging station.

3. The method of claim 1, wherein the connection indication indicates whether the registered vehicle and/or a vehicle associated with the registered user is connected to the charging station, is within a structure associated with the charging station, and/or is connected to a wireless network associated with the charging station.

4. The method of claim 1, wherein the connection indication indicates that a vehicle has been connected to a specific port.

5. The method of claim 1, further comprising generating or updating a behavioral model of the registered user and/or a behavioral model of the registered vehicle based on the initiation of the charging of the battery of the vehicle via the charging station.

6. The method of claim 5, further comprising generating or updating a charging schedule based on the behavioral model of the registered user and/or the behavioral model of the registered vehicle.

7. The method of claim 5, wherein charging of the battery of the vehicle via the charging station is controlled based on the behavioral model of the registered user and/or the behavioral model of the registered vehicle.

8. A device for vehicle battery charging, the device comprising:
circuitry configured to receive a connection indication indicating that a vehicle has been connected to a charging station;
circuitry configured to receive a proximity indication indicating that a registered vehicle and/or registered user associated with the charging station is proximate to the charging station; and
circuitry configured to, responsive to the proximity indication indicating that the registered vehicle and/or registered user is proximate to the charging station, initiate charging of a battery of the vehicle via the charging station.

9. The device of claim 8, wherein the proximity indication indicates whether the registered vehicle and/or registered user is within a threshold distance from the charging station, within a structure associated with the charging station, within a boundary associated with the charging station, within a geofence associated with the charging station, and/or connected to a wireless network associated with the charging station.

10. The device of claim 8, wherein the connection indication indicates whether the registered vehicle and/or a vehicle associated with the registered user is connected to the charging station, is within a structure associated with the charging station, and/or is connected to a wireless network associated with the charging station.

11. The device of claim 8, wherein the connection indication indicates that a vehicle has been connected to a specific port.

12. The device of claim 8, further comprising circuitry configured to generate or update a behavioral model of the registered user and/or a behavioral model of the registered vehicle based on the initiation of the charging of the battery of the vehicle via the charging station.

13. The device of claim 12, further comprising circuitry configured to generate or update a charging schedule based on the behavioral model of the registered user and/or the behavioral model of the registered vehicle.

14. The device of claim 12, further comprising circuitry configured to control charging of the battery of the vehicle via the charging station based on the behavioral model of the registered user and/or the behavioral model of the registered vehicle.

15. A non-transitory computer-readable medium comprising instructions thereon which when executed by a processor cause the processor to:
receive a connection indication indicating that a vehicle has been connected to a charging station;
receive a proximity indication indicating that a registered vehicle and/or registered user associated with the charging station is proximate to the charging station; and
responsive to the proximity indication indicating that the registered vehicle and/or registered user is proximate to the charging station, initiate charging of a battery of the vehicle via the charging station.

16. The non-transitory computer-readable medium of claim 15, wherein the proximity indication indicates whether the registered vehicle and/or registered user is within a threshold distance from the charging station, within a structure associated with the charging station, within a boundary associated with the charging station, within a geofence associated with the charging station, and/or connected to a wireless network associated with the charging station.

17. The non-transitory computer-readable medium of claim 15, wherein the connection indication indicates whether the registered vehicle and/or a vehicle associated with the registered user is connected to the charging station, is within a structure associated with the charging station, and/or is connected to a wireless network associated with the charging station.

18. The non-transitory computer-readable medium of claim 15, wherein the connection indication indicates that a vehicle has been connected to a specific port.

19. The non-transitory computer-readable medium of claim 15, further comprising instructions thereon which when executed by a processor cause the processor to generate or update a behavioral model of the registered user and/or a behavioral model of the registered vehicle based on the initiation of the charging of the battery of the vehicle via the charging station.

20. The non-transitory computer-readable medium of claim 19, further comprising instructions thereon which when executed by a processor cause the processor to generate or update a charging schedule based on the behavioral model of the registered user and/or the behavioral model of the registered vehicle.
